(19) United States
(12) Patent Application Publication
(10) Pub. No.: US 2026/0067898 A1
(43) Pub. Date: Mar. 5, 2026

(54) XR Data Transmission and Reception During Measurement Gaps

(71) Applicant: NANJING XINXUNBIAO TECHNOLOGY CO., LTD., Jiangsu (CN)

(72) Inventor: Bing HUI, Jiangsu (CN)

(73) Assignee: NANJING XINXUNBIAO TECHNOLOGY CO., LTD., Jiangsu (CN)

(21) Appl. No.: 19/382,160

(22) Filed: Nov. 6, 2025

Related U.S. Application Data
(63) Continuation of application No. PCT/CN2024/110649, filed on Aug. 8, 2024.

(51) Int. Cl. H04W 72/232

(52) U.S. Cl. CPC H04W 72/232

(57) ABSTRACT

A wireless device receives, from a base station, a plurality of downlink control information (DCI) comprising a first DCI and a second DCI. The first DCI indicates the wireless device to cancel a measurement gap (MG) occasion for a radio resource management (RRM) measurement. The second DCI indicates the wireless device to perform the RRM measurement during the MG occasion. In response to the receiving of the second DCI being later than the receiving of the first DCI, the wireless device performs, based on the second DCI, the RRM measurement during the MG occasion.

### CROSS-REFERENCE TO RELATED APPLICATIONS

This application is a continuation of International Application No. PCT/CN2024/110649, filed Aug. 8, 2024, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an example of a mobile communication network in which embodiments of the present disclosure may be implemented.

FIG. 2A and FIG. 2B respectively illustrate a NR user plane and a NR control plane protocol stack.

FIG. 3 illustrates an example configuration of an NR frame and an example configuration of a slot in the time and frequency domain for an NR carrier.

FIG. 4 illustrates an example of bandwidth adaptation using three configured BWPs for an NR carrier as per an aspect of an example embodiment of the present disclosure.

FIG. 5 illustrates three carrier aggregation configurations with two component carriers as per an aspect of an example embodiment of the present disclosure.

FIG. 6 illustrates an example of a wireless device in communication with a base station in accordance with embodiments of the present disclosure.

FIG. 7 illustrates an example of configuration parameters of a measurement gap as per an aspect of an example embodiment of the present disclosure.

FIG. 8 illustrates examples of configured MGs of a wireless device as per an aspect of an example embodiment of the present disclosure.

FIG. 9 illustrates an example of enabling Tx/Rx in gaps/restrictions of RRM measurements as per an aspect of an example embodiment of the present disclosure.

FIG. 10A and FIG. 10B illustrate examples of enabling Tx/Rx in gaps/restrictions of RRM measurements as per an aspect of an example embodiment of the present disclosure.

FIG. 11 illustrates an example of an indication for skipping/canceling/deactivating one or more MG occasions as per an aspect of an example embodiment of the present disclosure.

FIG. 12 illustrates an example of performing measurements in a skipped/cancelled/deactivated MG occasion as per an aspect of an example embodiment of the present disclosure.

FIG. 13 illustrates an example of performing measurements in a skipped/cancelled/deactivated MG occasion as per an aspect of an example embodiment of the present disclosure.

FIG. 14 illustrates an example of performing measurements in a skipped/cancelled/deactivated MG occasion as per an aspect of an example embodiment of the present disclosure.

FIG. 15 illustrates an example flow diagram of performing measurements in a skipped/cancelled/deactivated MG occasion as per an aspect of an example embodiment of the present disclosure.

### DETAILED DESCRIPTION

In the present disclosure, various embodiments are presented as examples of how the disclosed techniques may be implemented and/or practiced in environments and scenarios. A person having ordinary skills in the art will readily recognize that the teachings of the example embodiments in the present disclosure can be applied in a multitude of different ways. Some or all of the described examples may be implemented in any device, system or network that is capable of transmitting and receiving radio frequency (RF) signals according to the Institute of Electrical and Electronics Engineers (IEEE) 802.11 standards, IEEE 802.15 standards, the Bluetooth standards, or the Long Term Revolution (LTE), 3^{rd} generation (3G), fourth generation (4G), fifth generation (5G) new radio (NR) standards, and those of future networks yet to be specified (e.g., a 3GPP 6G network), or any others. The embodiments of the present disclosure will be described with reference to accompanying drawings. Limitations, features, and/or elements from the disclosed example embodiments may be combined to create further embodiments within the scope of the disclosure.

In the present disclosure, “a”, “an”, and any term that ends with the suffix “(s)” should be interpreted as “at least one” and “one or more.” In this disclosure, the term “may” should be interpreted as “may, for example.” In other words, a phrase following the term “may” is an example of one of a multitude of suitable possibilities that may, or may not, be employed by one or more of the various embodiments. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

In the present disclosure, the term base station may refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one gNB Distributed Unit (gNB-DU).

In the present disclosure, the term wireless device may refer to and encompass any mobile device or fixed (non-mobile) device for which wireless communication is desired or usable. For example, a wireless device may be a telephone, smart phone, tablet, computer, laptop, sensor, meter, wearable device, Internet of Things (IoT) device, vehicle road side unit (RSU), relay node, automobile, electric vehicle (EV) charger, extended reality (XR) glasses/goggles, and/or any combination thereof. The term wireless device encompasses other terminology, including user equipment (UE), user terminal (UT), access terminal (AT), mobile station, handset, wireless transmit and receive unit (WTRU), and/or wireless communication device.

In the present disclosure, the term configured may refer to specific settings in a device that affect the operational characteristics of the device whether the device is in an operational or non-operational state. For example, hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In the present disclosure, parameters (or equally called, fields, or Information elements (IEs)) may comprise one or more information objects. In an example, the parameters may comprise the one or more information objects in a nested way. For example, a first parameter (e.g., a first IE) may comprise a second parameter (e.g., a second IE) and a third parameter (e.g., a third IE), when the first parameter comprises the second parameter and the second parameter comprises the third parameter. In an example embodiment, one or more messages comprise a plurality of parameters may imply that a parameter of the plurality of parameters is in at least one of the one or more messages, but does not have to be in each of the one or more messages.

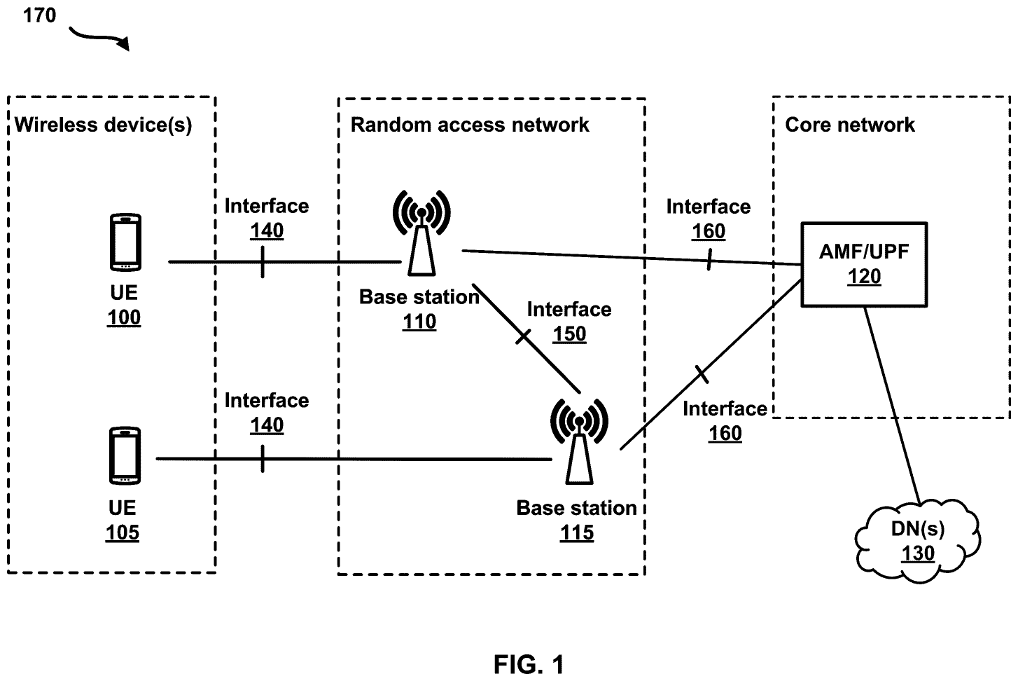

FIG. 1 illustrates an example of a mobile communication network 170 in which embodiments of the present disclosure may be implemented. The mobile communication network 170 may be, for example, a public land mobile network (PLMN) run by a network operator. As illustrated in FIG. 1, the mobile communication network 170 may comprise one or more wireless devices (e.g., a user equipment (UE) 100 and/or a UE 105), a radio access network (RAN) (e.g., a base station 110 and/or a base station 115), and a core network (CN).

The CN may provide the one or more wireless devices with an interface to one or more data networks (DNs) (e.g., DNs 130), such as public DNS (e.g., the Internet), private DNs, and/or intra-operator DNs. As part of the interface functionality, the CN may set up end-to-end connections between the one or more wireless devices and the one or more DNs, authenticate the one or more wireless devices, and provide charging functionality. In an example of a new radio (NR) system in FIG. 1, a CN may comprise an Access and Mobility Management Function (AMF) and a User Plane Function (UPF), which are shown as one component AMF/UPF 120 in FIG. 1 for ease of illustration. The UPF may serve as a gateway between the RAN and the one or more DNs. The UPF may perform functions such as packet routing and forwarding, packet inspection and user plane policy rule enforcement, traffic usage reporting, uplink classification to support routing of traffic flows to the one or more DNs, quality of service (QOS) handling for the user plane (e.g., packet filtering, gating, uplink/downlink rate enforcement, and uplink traffic verification), downlink packet buffering, and downlink data notification triggering. The AMF may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The RAN may connect the CN to the one or more wireless devices through radio communications over an air interface. As part of the radio communications, the RAN may provide scheduling, radio resource management, and retransmission protocols. A communication direction from the RAN to the one or more wireless devices (e.g., from the base station 110 to the UE 100) over the air interface is known as a downlink. A communication direction from the one or more wireless devices (e.g., from the UE 100 to the base station 110) to the RAN over the air interface is known as an uplink. The downlink transmissions may be separated from the uplink transmissions using frequency division duplexing (FDD), time-division duplexing (TDD), and/or some combination of the two duplexing techniques. In an example of a new radio (NR) system in FIG. 1, the RAN may comprise one or more base stations. A UE of the one or more wireless devices (e.g., the UE 100 and the UE 105) and a base station of the one or more base stations (e.g., the base station 110 and the base station 115) may be connected by means of a Uu interface (e.g., an interface 140 in FIG. 1). A first base station of the one or more base stations (e.g., the base station 110) and a second base station of the one or more base stations (e.g., the base station 115) may be connected by means of a Xn interface (e.g., an interface 150 in FIG. 1). A base station of the one or more base stations in the RAN and the AMF/UPF in the CN may be connected by means of a NG interface (e.g., an interface 160 in FIG. 1).

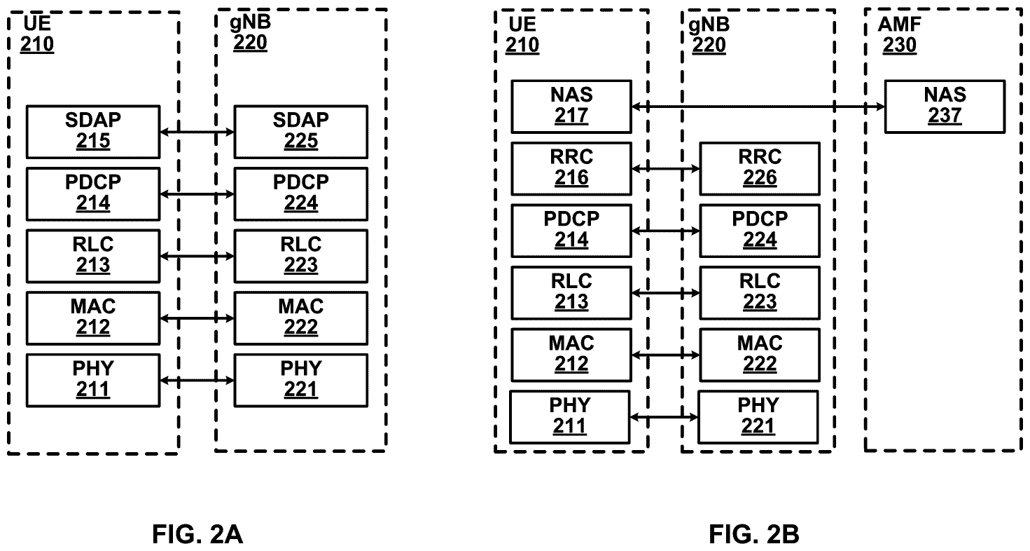

FIG. 2A illustrates a NR user plane protocol stack comprising five layers implemented in a UE 210 and a gNB 220. The NR user plane protocol stack comprises physical layers (PHYs) 211 and 221 providing transport services to the higher layers of the protocol stack and may correspond to layer 1 of the Open Systems Interconnection (OSI) model. The NR user plane protocol stack comprises media access control (sub)layers (MACs) 212 and 222, radio link control (sub)layers (RLCs) 213 and 223, packet data convergence protocol (sub)layers (PDCPs) 214 and 224, and service data application protocol (sub)layers (SDAPs) 215 and 225. The MACs (e.g., 212 and 222), the RLCs (e.g., 213 and 223), the PDCPs (e.g., 214 and 224), and the SDAPs (e.g., 215 and 225) may make up layer 2 (e.g., or be known as sublayers of the layer 2), or the data link layer, of the OSI model.

FIG. 2B illustrates an example NR control plane protocol stack. As shown in FIG. 2B, the NR control plane protocol stack comprises the PHY layers 211 and 221. The NR control plane protocol stack has the MAC (sub)layers 212 and 222, the RLC (sub)layers 213 and 223, the PDCP (sub)layers 214 and 224 (e.g., terminated in the gNB 220 on network side). The NR control plane protocol stack has radio resource controls (RRCs) 216 and 226 (e.g., terminated in the gNB 220 on network side). The NR control protocol stack has NAS control protocols 217 and 237 (e.g., terminated in an AMF 230 on network side) performs the functions, for instance: authentication, mobility management, security control, etc.

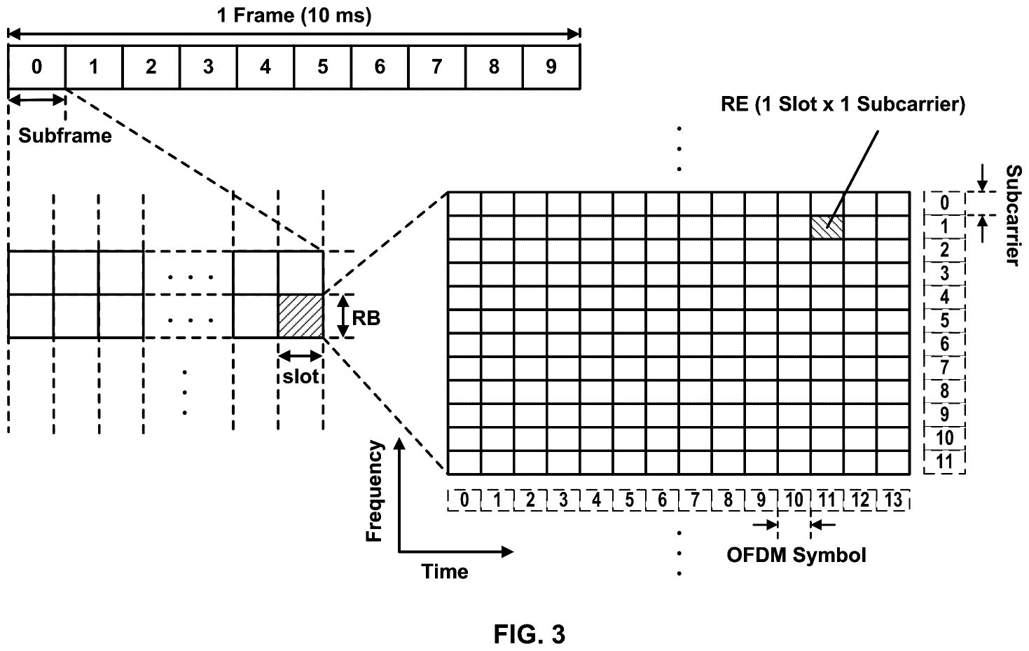

FIG. 3 illustrates an example configuration of an NR frame. Orthogonal frequency divisional multiplexing (OFDM) symbols are grouped into the NR frame. In NR, physical signals and physical channels may be mapped onto OFDM symbols. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

FIG. 3 further illustrates an example configuration of a slot in the time and frequency domain for an NR carrier. The slot includes resource elements (REs) and resource blocks (RBs). An RE is the smallest physical resource (e.g., physical radio resource) in NR. In FIG. 3, an RE spans 1 OFDM symbol in the time domain by 1 subcarrier in the frequency domain. An RB spans 12 consecutive REs (e.g., 12 subcarriers) in the frequency domain, and one slot (e.g., 14 consecutive OFDM symbols) in the time domain. FIG. 3 illustrates an example of a single numerology being used across the entire bandwidth of the NR carrier. In other example configurations, multiple numerologies may be supported on the same carrier.

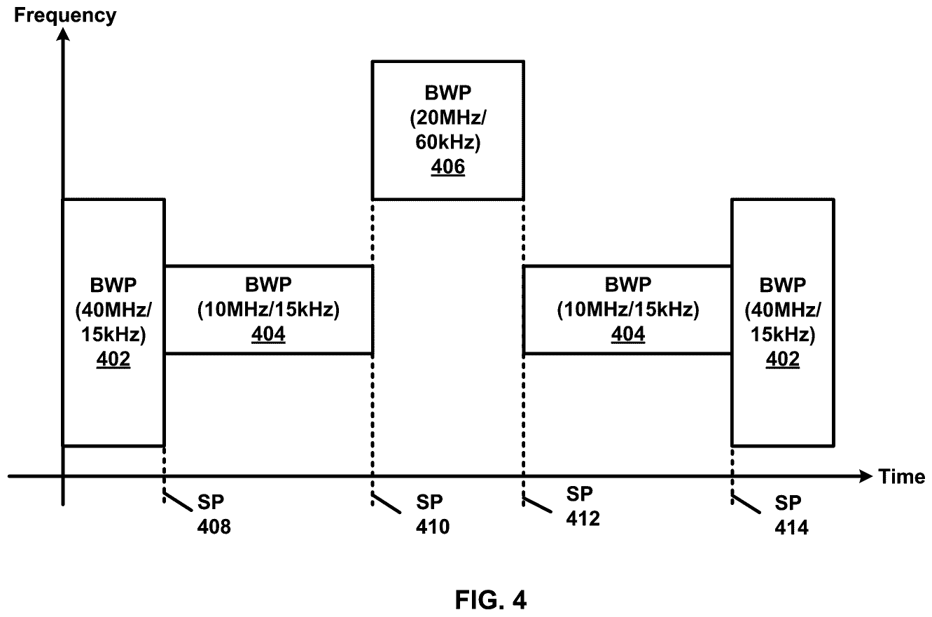

FIG. 4 illustrates an example of bandwidth adaptation (BA) using three configured BWPs for an NR carrier (e.g., a primary cell and/or a secondary cell of a UE). With bandwidth adaptation, a transmit and/or receive bandwidth of a UE may not be as large as a bandwidth of a cell. The transmit and/or receive bandwidth of the UE may be adjusted. In an example, a width of the transmit and/or receive bandwidth may be ordered to change (e.g., to save power of the UE). In an example, a location of the transmit and/or receive bandwidth may move in the frequency domain (e.g. to increase scheduling flexibility of the UE). In an example, a subcarrier spacing (e.g., numerology) of the transmit and/or receive bandwidth may be ordered to change (e.g. to allow different services of the UE). In an example, a subset of a cell bandwidth of the cell may be referred to as a Bandwidth Part (BWP). For achieving bandwidth adaptation, one or more BWPs may be configured and/or pre-configured to a UE. Network (e.g., a base station) may indicate the UE which of the configured/pre-configured one or more BWPs is currently an active BWP.

In an example of FIG. 4, a UE may be configured with three BWPs. The BWPs comprise a BWP 402 with a bandwidth of 40 MHz and a subcarrier spacing of 15 kHz, a BWP 404 with a bandwidth of 10 MHz and a subcarrier spacing of 15 kHz, and a BWP 406 with a bandwidth of 20 MHz and a subcarrier spacing of 60 kHz. The UE may switch from a first BWP to a second BWP at a switching point, for example, based on an expiry of a BWP inactivity timer (e.g., indicating switching to a default BWP) and/or in response to receiving a downlink control information (DCI) indicating the second BWP as an active BWP. In the example of FIG. 4, the UE may switch from the BWP 402 to the BWP 404 at a switching point 408 based on an expiry of a BWP inactivity timer (e.g., indicating switching to a default BWP), when the BWP 402 is an initial active BWP and the BWP 404 is a default BWP. In another example of FIG. 4, the UE may switch from the BWP 402 to the BWP 404 at a switching point 408 in response to receiving a DCI indicating the BWP 404 as an active BWP. The UE may switch, at a switching point 410, from the BWP 404 to the BWP 406 in response receiving a DCI indicating the BWP 406 as an active BWP. The UE may switch, at a switching point 412, from the BWP 406 to the BWP 404 in response to an expiry of a BWP inactivity timer and/or in response receiving a DCI indicating the BWP 404 as an active BWP. The UE may switch, at a switching point 414, from the BWP 404 to the BWP 402 in response to receiving a DCI indicating the BWP 402 as an active BWP.

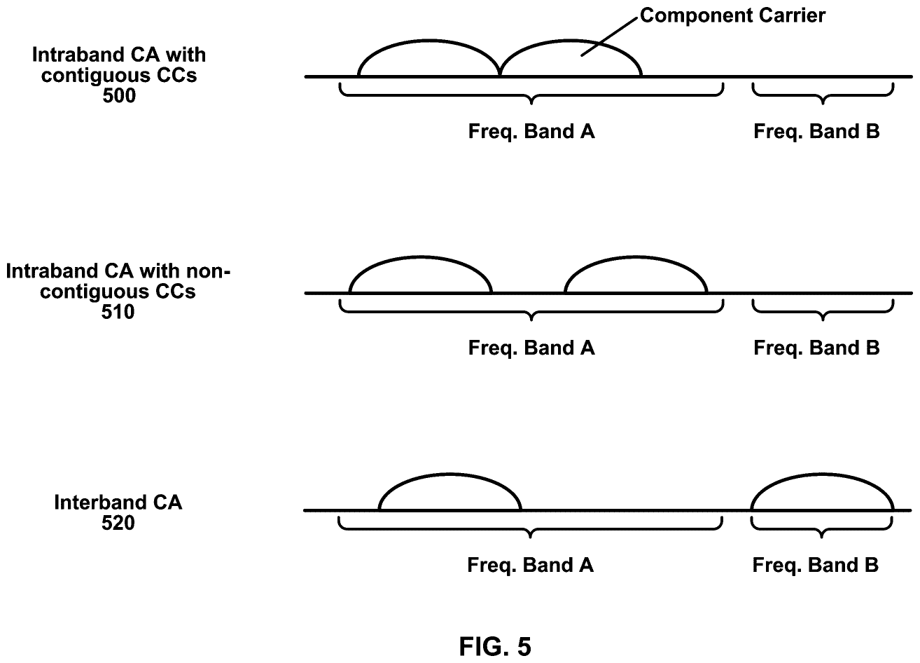

FIG. 5 illustrates three carrier aggregation (CA) configurations with two component carriers (CCs). Carrier aggregation for a UE may be supported for providing greater data rates. Two or more carriers can be aggregated and simultaneously transmitted to/from the same UE using carrier aggregation. The aggregated carriers in CA may be referred to as component carriers. When CA is used, there are a number of serving cells for the UE, one for a CC. The CCs may have three configurations in the frequency domain.

As shown in FIG. 5, in a first configuration for intraband CA with contiguous CCs 500, two contiguous CCs are aggregated in the same frequency band (frequency band A) and are located adjacent to each other within the frequency band. In a second configuration for intraband CA with non-contiguous CCs 510, two CCs are aggregated in the same frequency band (frequency band A) and are separated in the frequency band by a gap. In a third configuration for interband CA 520, two CCs are located in frequency bands (frequency band A and frequency band B). In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell.

When CA is configured to a wireless device with a plurality of aggregated cells, a first serving cell of the plurality of aggregated cells may be referred to as a Primary Cell (PCell) for the wireless device. The PCell may be the serving cell that the wireless device initially connects to. The PCell may provide, to the wireless device, NAS mobility function at RRC connection establishment/re-establishment/handover. The PCell may provide, to the wireless device, security input at RRC re-establishment/handover. A second serving cell of the plurality of aggregated cells may be referred to as a Secondary Cell (SCell) for the wireless device. The PCell and the SCell of the wireless device are different serving cells. Depending on UE capabilities of the wireless device, one or more SCells may be configured, to the wireless device, with the PCell to form a set of serving cells for the wireless device.

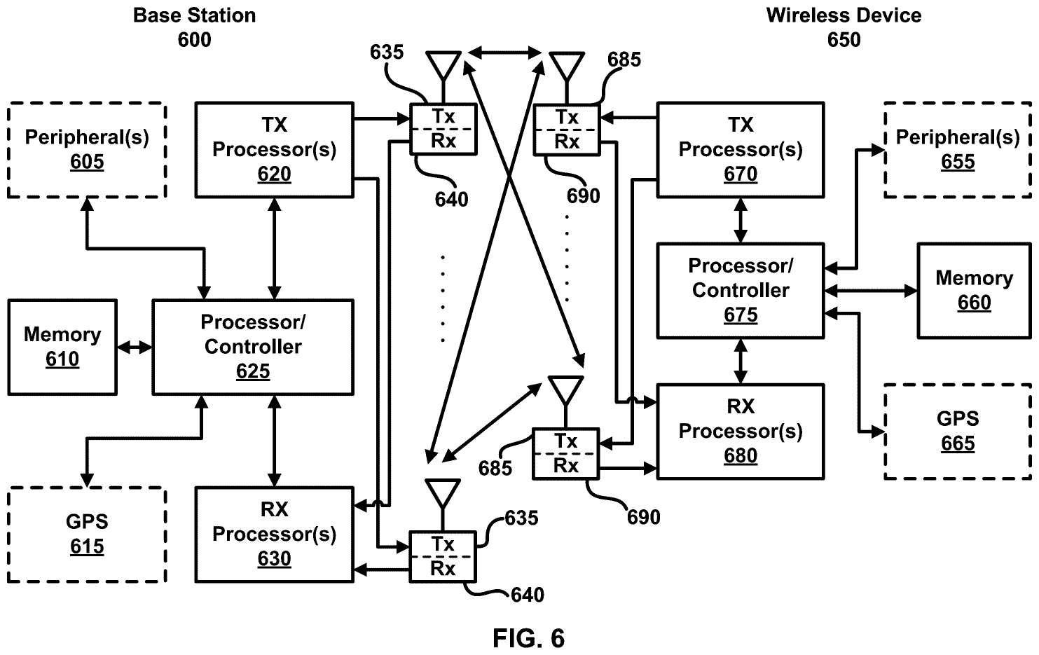

FIG. 6 illustrates an example of a wireless device 650 in communication with a base station 600 in accordance with embodiments of the present disclosure. The wireless device 650 and base station 600 may be part of a mobile communication network, such as the mobile communication network 170 illustrated in FIG. 1 or any other communication network. The base station 600 may connect the wireless device 650 to a core network (not shown) through radio communications over an air interface (or radio interface). The communication direction from the base station 600 to the wireless device 650 over the air interface is known as a downlink, and the communication direction from the wireless device 650 to the base station 600 over the air interface is known as an uplink.

In the downlink, downlink data to be sent, to the wireless device 650 from the base station 600, may be provided to a processor/controller 625 of the base station 600.

The downlink data may be provided to the processor/controller 625 by, for example, a core network. The processor/controller 625 may implement layer 3 and layer 2 OSI functionality to process the downlink data for transmission. Layer 3 may include an RRC layer. Layer 2 may include an SDAP layer, a PDCP layer, an RLC layer, and a MAC layer. The processor/controller 625 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through Automatic Repeat reQuest (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through Hybrid ARQ (HARQ), priority handling, and logical channel prioritization.

In the downlink and after being processed by the processor/controller 625, the downlink data may be provided to one or more transmit (Tx) processors 620 of base station 600. The one or more Tx processors 620 may implement layer 1 OSI functionality. Layer 1 may comprise a PHY layer. The PHY layer may perform, for example, forward error correction (FEC) coding of transport channels, interleaving, rate matching, mapping of transport channels to physical channels, modulation of physical channel, multiple-input multiple-output (MIMO) or multi-antenna processing, and/or the like. The one or more Tx processors 620 may map the downlink data to coded and modulated symbols based on various modulation schemes (e.g., binary phase-shift keying (BPSK), quadrature phase-shift keying (QPSK), M-phase-shift keying (M-PSK), M-quadrature amplitude modulation (M-QAM)) and coding schemes (e.g., convolution code, turbo code, and/or low density parity check (LDPC) code). The coded and modulated symbols of the downlink data may be split into parallel streams. Each stream of the parallel streams may be mapped to an OFDM subcarrier, multiplexed with a reference signal (e.g., pilot) in the time and/or frequency-domain, and combined using an Inverse Fast Fourier Transform (IFFT) to produce a physical channel carrying a time-domain OFDM symbol stream. The OFDM stream may be spatially precoded to produce multiple spatial streams. A channel estimator (not shown in FIG. 6) may be used to determine the modulation schemes, the coding schemes, and/or for spatial processing. Each spatial stream of the multiple spatial streams may be provided to different antenna via a separate transmitter Tx 635. Each transmitter Tx 635 may modulate a radio frequency (RF) carrier with a respective spatial stream for transmission.

In the downlink and at the wireless device 650, each of the one or more receivers Rx 690 receives a signal through respective antenna. The one or more receivers Rx 690 may recover received information, modulated onto the RF carrier, and provide the received information to one or more receive (Rx) processors 680 of the wireless device 650. The one or more Rx processors 680 may implement layer 1 OSI functionality. The one or more Rx processors 680 may perform spatial processing on the received information to recover one or more spatial streams desired for the wireless device 650. If multiple spatial streams are desired for the wireless device 650, the one or more Rx processors 680 may combine the multiple spatial streams into a single OFDM symbol stream. The one or more Rx processors 680 may convert the OFDM symbol stream from the time-domain to the frequency-domain using a Fast Fourier Transform (FFT). The OFDM symbol stream may be demodulated and decoded, to recover the downlink data and/or control signal transmitted by the base station 600 on physical channel, based on a channel estimator at the wireless device 650 (not shown in FIG. 6). The data and control signals are then provided to the processor/controller 675, which implements layer 3 and layer 2 functionality.

In the uplink, uplink data to be sent, from the wireless device 650 to the base station 600, may be provided to the processor/controller 675 of the wireless device 650. Similar to the downlink, the processor/controller 675 may implement layer 3 and layer 2 OSI functionality to process the uplink data for transmission.

In the uplink and after being processed by the processor/controller 675, the uplink data may be provided to one or more Tx processors 670 of the wireless device 650. Similar to the downlink, the one or more Tx processors 670 may implement layer 1 OSI functionality. The one or more Tx processors 670 may map the uplink data to coded and modulated symbols based on various modulation schemes and coding schemes. The coded and modulated symbols of the uplink data may be split into parallel streams. Each stream of the parallel streams may be mapped to an OFDM subcarrier, multiplexed with a reference signal (e.g., pilot) in the time and/or frequency-domain, and combined using an IFFT to produce a physical channel carrying a time-domain OFDM symbol stream. The OFDM stream may be spatially precoded to produce multiple spatial streams. A channel estimator (not shown in FIG. 6) may be used to determine the modulation schemes, the coding schemes, and/or for spatial processing. Each spatial stream of the multiple spatial streams may be provided to different antenna via a separate transmitter Tx 685. Each transmitter Tx 685 may modulate a RF carrier with a respective spatial stream for transmission.

In the uplink and at the base station 600, each of the one or more receivers Rx 640 receives a signal through respective antenna. The one or more receivers Rx 640 may recover received information, modulated onto the RF carrier, and provide the received information to one or more Rx processors 630 of the base station 600. The one or more Rx processors 630 may implement layer 1 OSI functionality. The one or more Rx processors 630 may perform spatial processing on the received information to recover one or more spatial streams desired for the base station 600. If multiple spatial streams are desired for the base station 600, the one or more Rx processors 630 may combine the multiple spatial streams into a single OFDM symbol stream. The one or more Rx processors 630 may convert the OFDM symbol stream from the time-domain to the frequency-domain using an FFT. The OFDM symbol stream may be demodulated and decoded, to recover the uplink data and/or control signal transmitted by the wireless device 650 on physical channel, based on a channel estimator at the base station 600 (not shown in FIG. 6). The data and control signals are then provided to the processor/controller 625, which implements layer 3 and layer 2 functionality.

As shown in FIG. 6, the wireless device 650 and the base station 600 may have multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 650 and/or the base station 600 may have a single antenna.

The processor/controller 625 and/or the processor/controller 675 may be associated with a memory 610 and a memory 660, respectively. Memory 610 and memory 660 (e.g., one or more non-transitory computer readable mediums) may store computer program instructions or code that may be executed by the processor/controller 625 and/or the processor/controller 675 to carry out one or more of the functionalities discussed in the present application. Although not shown in FIG. 6, the one or more Tx processors 620, the one or more Tx processors 670, the one or more Rx processors 630, and/or the one or more Rx processors 690 may be coupled to a memory (e.g., one or more non-transitory computer readable mediums) storing computer program instructions or code that may be executed to carry out one or more of their respective functionalities.

The processor/controller 625 and/or the processor/controller 675 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processor/controller 625 and/or the processor/controller 675 may perform at least one of signal coding/processing, data processing, power control, input/output processing, and/or any other functionality that may enable the wireless device 650 and the base station 600 to operate in a wireless environment.

The processor/controller 625 and/or the processor/controller 675 may be connected to one or more peripherals 605 and one or more peripherals 655, respectively. The one or more peripherals 605 and the one or more peripherals 655 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processor/controller 625 and/or the processor/controller 675 may receive user input data from and/or provide user output data to the one or more peripherals 605 and/or the one or more peripherals 655. The processor/controller 675 in the wireless device 650 may receive power from a power source and/or may be configured to distribute the power to the other components in the wireless device 650. The power source may comprise one or more sources of power, for example, a battery, a solar cell, a fuel cell, or any combination thereof. The processor/controller 625 and/or the processor/controller 675 may be connected to a GPS chipset 615 and a GPS chipset 625, respectively. The GPS chipset 615 and the GPS chipset 625 may be configured to provide geographic location information of the wireless device 650 and the base station 600, respectively.

In the present disclosure, a base station may communicate with various types/categories of wireless devices. Wireless devices and/or base stations may support different technologies, and/or different releases of the same technology. A downlink transmission from (e.g., by) a base station and to a wireless device may be the same as a downlink reception by the wireless device and from the base station. An uplink transmission from (e.g., by) a wireless device to a base station may be the same as an uplink reception by the base station and from the wireless device.

In the present disclosure, a wireless device may receive from a base station one or more messages (e.g. RRC messages) comprising configuration parameters of one or more cells (e.g. primary cell, secondary cell). The wireless device may communicate with at least one base station of the one or more cells. The one or more messages (e.g. as a part of the configuration parameters) may comprise parameters of PHY, MAC, RLC, PCDP, SDAP, and/or RRC layers for configuring the wireless device. For example, the configuration parameters may comprise parameters for configuring PHY and MAC layer channels, bearers, etc. For example, the configuration parameters may comprise parameters indicating values of timers for PHY, MAC, RLC, PCDP, SDAP, RRC layers, and/or communication channels.

In the present disclosure, a wireless device and a base station may exchange control signaling (e.g., referred to as L1/L2 control signaling and may originate from the PHY layer (e.g., layer 1) and/or the MAC layer (e.g., layer 2)). The control signaling may comprise downlink control signaling (e.g., MAC control element (MAC CE) and/or DCI) transmitted from the base station to the UE and/or uplink control signaling (e.g., MAC CE and/or uplink control information (UCI)) transmitted from the UE to the base station.

In the present disclosure, an uplink configurated grant (CG) configuration may be a type 1 CG configuration. A base station may transmit an RRC message to a wireless device for configuring uplink transmission occasions/resources based on the type 1 CG configuration. In response to receiving the RRC message, the wireless device may activate the uplink transmission occasions/resources without further message/signaling for activation of the CG configuration.

In the present disclosure, an uplink CG configuration may be a type 2 CG configuration. A base station may transmit an RRC message to a wireless device for configuring uplink transmission occasions/resources based on the type 2 CG configuration. In response to receiving the RRC message, the wireless device may not activate the uplink transmission occasions/resources. The base station may further transmit a DCI to the wireless device for activating/releasing the uplink transmission occasions/resources.

In an example, a wireless device may perform one or more measurements on downlink signals of neighboring cells and/or other CCs. The one or more measurements may be radio resource management (RRM) measurements. The wireless device may perform the one or more RRM measurements for evaluating signal quality of the neighboring cells and/or the other CCs (e.g., for initiating random access and/or handover, etc.). The downlink signals may be synchronization signals (SS) and physical broadcast channel (PBCH) blocks (SSBs), channel state information reference signals (CSI-RSs), and/or positioning reference signals (PRSs). The wireless device may perform intra-frequency, inter-frequency and/or inter radio access technology (RAT) measurements of the downlink signals during a time interval. The wireless device may not transmit to or receive from a serving cell (e.g., suspend transmission/reception) during the time interval to avoid interference to the measurements (e.g., the RRM measurements). The time interval, during which the wireless device performs the RRM measurements of the neighbor cells and/or the other CCs, may be a measurement gap (MG). Scheduling restrictions may apply to the RRM measurements of the wireless device during the MG, where the wireless device is performing intra-frequency RRM measurements at FR2, or gap assisted inter-frequency RRM measurements. In an example, FR1 may consist of Frequency operating bands for 5G NR below 7125 MHz (410 MHz-7125 MHz). FR2 may consist of Frequency operating bands for 5G NR FR2-1 (24250 MHz-52600 MHZ) and FR2-2 (52600 MHZ-71000 MHz). The scheduling restrictions may not allow the wireless device to transmit physical uplink control channel (PUCCH), physical uplink shared channel (PUSCH) and/or sounding reference signal (SRS); or receive physical downlink control channel (PDCCH), physical downlink shared channel (PDSCH) and/or CSI-RS. When a frame arrival of the wireless device collides with the RRM measurements, the frame may be delayed for a duration of SSB measurement timing configuration (SMTC) window or a duration of the MG. In an example, a base station (e.g., network) may send/transmit to a wireless device a message comprising configuration parameters for configuring one or more MGs of a wireless device. In another example, one or more MGs may be preconfigured to a wireless device.

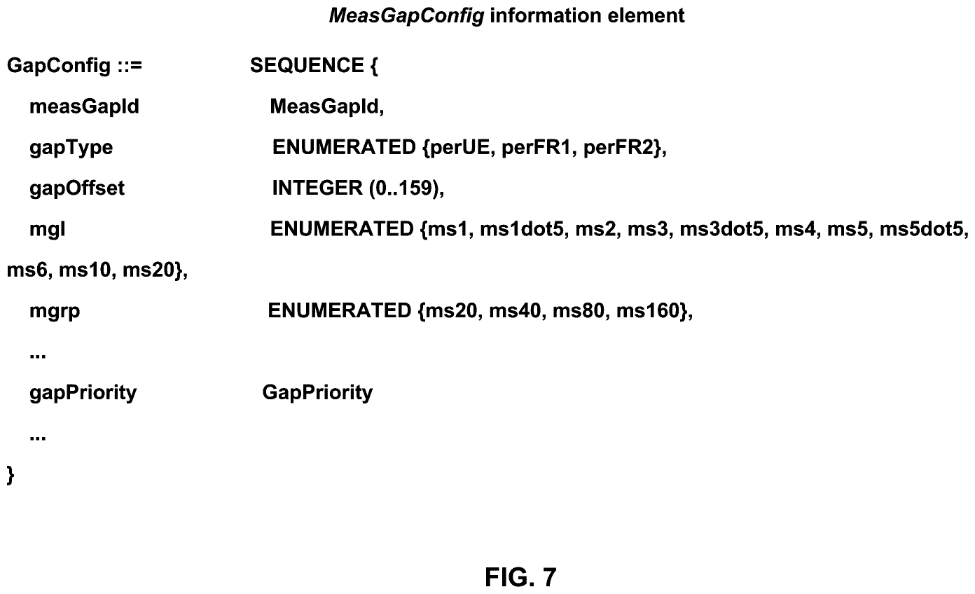

FIG. 7 illustrates an example of configuration parameters of a measurement gap. In FIG. 7, a base station (e.g., network) may transmit, to a wireless device, an RRC message. The RRC message may comprise an information element (e.g., MeasGapConfig IE) for specifying a measurement gap configuration and controls setup/release of MGs of the wireless device. A field (e.g., GapConfig) of the IE (e.g., MeasGapConfig IE) may comprise a first parameter (e.g., measGapId) indicating an identity/index (ID) of the measurement gap configuration. The field (e.g., GapConfig) may comprise a second parameter (e.g., gapType) indicating a type of the MG configuration. A value perUE, of the second parameter, may indicate that the MG configuration is a per UE measurement gap; a value perFRI may indicate that the MG configuration is a frequency range 1 (FR1) measurement gap; a value perFR2 may indicate that the MG configuration is an FR2 measurement gap. The field (e.g., GapConfig) may comprise a third parameter (e.g., gapOffset) indicating a gap offset of a gap pattern with measurement gap repetition period (MGRP) indicated in a field mgrp. Value range of the third parameter (e.g., gapOffset) may be from 0 to mgrp-1. The field (e.g., GapConfig) may comprise a fourth parameter (e.g., mgl) indicating a measurement gap length (mgl) in millisecond (ms) of the measurement gap configuration. A value ms1dot5, of the fourth parameter, may correspond to 1.5 ms, ms3 may correspond to 3 ms and so on. The field (e.g., GapConfig) may comprise a fifth parameter (e.g., mgrp) indicating a measurement gap repetition period in millisecond of the measurement gap configuration. A value ms20, of the fifth parameter may indicate a MGRP of 20 ms, a value ms40 may indicate a MGRP of 40 ms, and so on. The field (e.g., GapConfig) may comprise a sixth parameter (e.g., gapPriority) indicating a priority of the measurement gap. A value 1, of the sixth parameter, may indicate highest priority, value 2 may indicate second level priority, and so on.

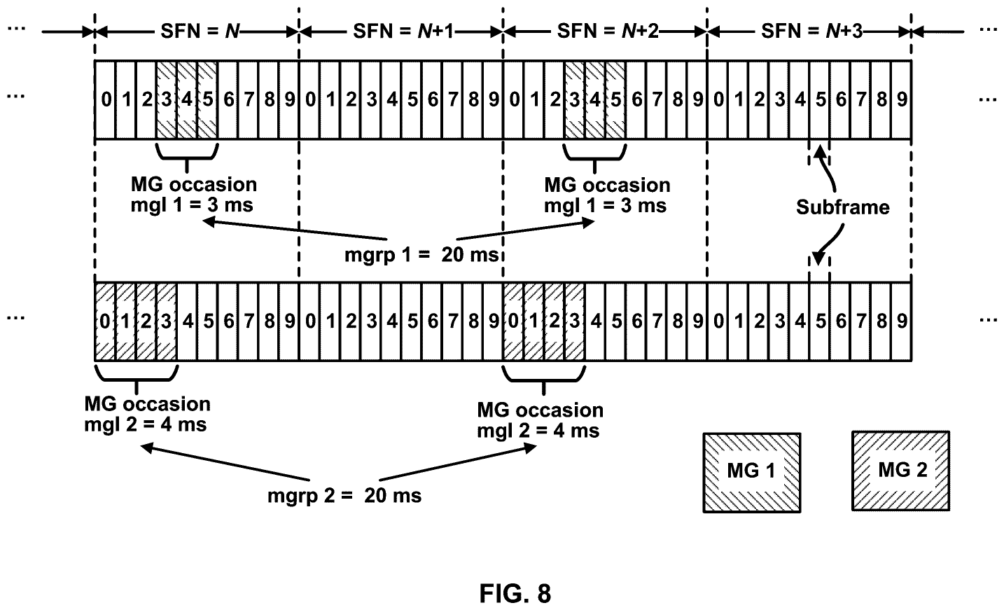

FIG. 8 illustrates examples of configured MG configurations of a wireless device. In an example, a base station may configure one or more MG configurations to a wireless device. In an example, one or more MG configurations may be preconfigured to a wireless device. In FIG. 8 and referring to FIG. 7, a first MG configuration (e.g., MG 1 marked as downward diagonal in FIG. 8) may have a first ID. The first MG configuration may be configured per UE, per FR1 and/or per FR2 based on gapType of the first MG configuration. A first MGL (e.g., mgl 1 in FIG. 8) of the first MG configuration may be 3 ms (e.g., a length of a MG occasion of the first MG configuration). A first MGRP (e.g., mgrp 1 in FIG. 8) of the first MG configuration may be 20 ms. A first MG occasion of the first MG configuration may start from the fourth subframe (e.g., based on gapOffset of the MG 1) in a first frame with SFN=N. A second MG occasion of the first MG configuration may start from the fourth subframe in a second frame with SFN=N+2, and repeated every 20 ms based on the first MGRP. The first MG configuration may have a first priority based on gapPriority of the first MG configuration. In FIG. 8 and referring to FIG. 7, a second MG configuration (e.g., MG 2 marked as upward diagonal in FIG. 8) may have a second ID. The second MG configuration may be configured per UE, per FR1 and/or per FR2 based on gapType of the second MG configuration. A second MGL (e.g., mgl 2 in FIG. 8) of the second MG configuration may be 4 ms (e.g., a length of a MG occasion of the second MG configuration). A second MGRP (e.g., mgrp 2 in FIG. 8) of the second MG configuration may be 20 ms. A first MG occasion of the second MG configuration may start from the first subframe (e.g., based on gapOffset of the MG 2) in a first frame with SFN=N. A second MG occasion of the second MG configuration may start from the first subframe in a second frame with SFN=N+2, and repeated every 20 ms based on the second MGRP. The second MG configuration may have a second priority based on gapPriority of the second MG.

In an example, a wireless device may determine two MG occasions (e.g., of two MG configurations) are colliding based on at least one of following conditions being met:
a first MG occasion of a first MG configuration is fully or partially overlapping in time domain with a second MG occasion of a second MG configuration, or
a distance between the first MG occasion of the first MG configuration and the second MG occasion of the second MG configuration is equal to or smaller than 4 ms.

The distance between the first MG occasion and the second MG occasion may be defined as a time difference between an ending point of the first MG occasion and a starting point of the second MG occasion, where the first MG occasion occurs earlier in time than the second MG occasion.

In case of collision between the first MG occasion and the second MG occasion, the wireless device may perform measurements in an occasion, between the first MG occasion and the second MG occasion, with higher priority. The wireless device may drop an occasion, between the first MG occasion and the second MG occasion, with lower priority. The wireless device may be able to transmit PUCCH/PUSCH/SRS, or receive PDCCH/PDSCH/TRS(e.g., tracking reference signal)/CSI-RS for channel quality indication (CQI) in a corresponding NR serving cell in slots that are not interrupted.

In FIG. 8, the wireless device may determine a collision between occasions of the first MG configuration and occasions of the second MG configuration (e.g., concurrent MGs) based on occasions of the first MG configuration overlapping with occasions of the second MG configuration in the time domain (e.g., both MG 1 and MG 2 comprise the fourth subframe with subframe index 3 in frame SFN=N and frame with SFN=N+2). The wireless device may compare the first priority of the first MG configuration with the second priority of the second MG configuration. In an example, the wireless device may perform measurements during the occasions of the first MG based on the first priority being higher than the second priority (e.g., a first value of the first priority being less than a second value of the second priority). The wireless device may drop the occasions of the second MG collided with the occasions of the first MG based on the first priority being higher than the second priority.

In existing technologies, a base station may transmit an indication to a wireless device to enable uplink transmissions and/or downlink receptions of extended Reality (XR) data traffic in gaps (e.g., MG occasions) and/or restrictions (e.g., scheduling restrictions) of RRM measurements. The XR may be an umbrella category comprising Virtual Reality (VR), Augmented Reality (AR), and Mixed Reality (MR). The enabling of uplink transmissions (Tx)/downlink receptions (Rx) during the MG occasions (e.g., or, in another word, skipping/canceling/deactivating of the MG occasions for the uplink Tx/downlink Rx) may help to boost system capacity.

Implementing the existing technologies, the wireless device may perform the uplink transmissions and/or downlink receptions during the MG occasions but not performing measurements (e.g., skip the MG occasions). The wireless device may not be capable of transmitting/sending, to the base station, measurement results/reports of the MG occasions. Measurement performance of the wireless device may degrade. Further actions of the base station and/or the wireless device based on the measurements during the MG occasions may fail. In an example when the skipped MG occasions are originally configured for measuring neighboring cells, the wireless device may experience handover failure to the neighboring cells in response to the skipping the MG occasions. Implementing the existing technologies, the skipped MG occasions may be available again later for measurements. For example, the skipped MG occasions may overlap with one or more unused transmission occasions for XR data traffic. In an example, skipping the MG occasions and not performing uplink transmissions and/or downlink receptions during the skipped MG occasions may waste chances for measurements during the MG occasions. In an example, skipping the MG occasions but not performing uplink transmissions and/or downlink receptions during the skipped MG occasions may reduce radio resource efficiency of the base station wireless device system.

Embodiments of the present disclosure may enable a wireless device to perform measurements during a skipped MG occasion in response to receiving an indication for skipping/canceling/deactivating the MG occasion. In an example embodiment, a wireless device may receive, from a base station, a RRC message comprising configuration parameters of a MG configuration for a RRM measurement by the wireless device. The wireless device may receive, from the base station, an indication for skipping an MG occasion of the MG configuration. The MG occasion may overlap with one or more radio resources in time domain. The one or more radio resources may comprise one or more uplink resources for uplink transmissions and/or one or more downlink resources for downlink receptions. The wireless device may determine that the one or more radio resources would not be used for uplink transmissions/downlink receptions. Based on the determining, the wireless device may perform the RRM measurement during the MG occasion. The wireless device may transmit, to the base station and based on the RRM measurement, a measurement result of the RRM measurement during the MG occasion. In an example embodiment, a wireless device may determine one or more uplink resources, overlapped with a MG occasion, being not used for uplink transmissions. The wireless device may transmit, to a base station and based on the determining, unused transmission occasion (UTO) uplink control information (UTO-UCI) indicating one or more uplink transmission occasions, when the one or more uplink transmission occasions comprise the one or more uplink resources. The wireless device may transmit the UTO-UCI is via a PUSCH. The wireless device may transmit the UTO-UCI is before the MG occasion. In an example embodiment, a wireless device may determine one or more uplink resources, overlapped with a MG occasion, being not used for uplink transmissions based on receiving downlink control information (DCI) indicating cancellation of the one or more uplink resources for the uplink transmissions. In an example embodiment, a wireless device may determine one or more downlink resources, overlapped with a MG occasion, being not used for downlink receptions based on receiving downlink control information (DCI) indicating pre-emption of the one or more downlink resources. In an example embodiment, a wireless device may receive a DCI indicating a type of a MG occasion to be skipped. The type of the MG occasion may indicate that the MG occasion would be used for only downlink receptions by a base station (e.g., or downlink receptions from the base station). The type of the MG occasion may indicate that the MG occasion would be used for only uplink transmissions by the wireless device (e.g., or uplink receptions by the base station). The type of the MG occasion may indicate that the MG occasion would be used for both uplink and downlink communications. In an example embodiment, a base station may transmit, to a wireless device, a RRC message comprising configuration parameters of a MG configuration for a RRM measurement by the wireless device. The base station may transmit, to the wireless device, an indication for skipping an MG occasion of the MG configuration. The MG occasion may overlap with one or more radio resources in time domain. The one or more radio resources may comprise one or more uplink resources for uplink transmissions and/or one or more downlink resources for downlink receptions. The base station may receive, from the wireless device and based on the RRM measurement, a measurement result of the RRM measurement.

Implementing the embodiments of the present disclosure may enable a wireless device to perform measurements during a skipped MG occasion. A base station may receive, from the wireless device, a measurement result/report of the measurements.

Consequently, resource wastage of skipped MG occasions and/or handover failure rate may be reduced. Implementing the embodiments of the present disclosure may improve system measurement performance during the skipped MG occasions. Implementing the embodiments of the present disclosure may increase flexibility for the base station and/or the wireless device to dynamically adjust/control usage of the skipped MG occasions.

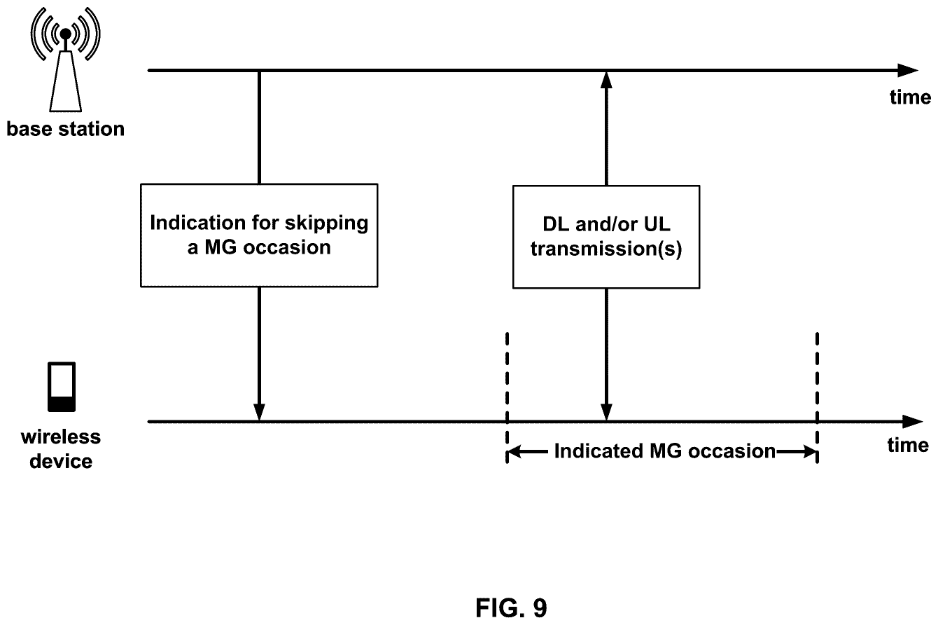

FIG. 9 illustrates an example of enabling Tx/Rx in gaps/restrictions of RRM measurements. In FIG. 9 and referring to FIG. 7 and FIG. 8, a base station (e.g., network) may transmit a message to a wireless device for configuring a MG configuration. The message may be an RRC message comprising configuration parameters of the MG configuration. The base station may transmit to the wireless device an indication for skipping/cancelling/deactivating a MG occasion of the MG configuration. The indication may enable the wireless device to perform uplink transmissions and/or downlink receptions (e.g., Tx/Rx) in the MG occasion (e.g., and/or scheduling restrictions) of the MG configuration. In response to the receiving of the indication, the wireless device may skip/cancel/deactivate the MG occasion for the RRM measurements (e.g., not perform the RRM measurement in the skipped/cancelled/deactivated MG occasion). The wireless device may perform Tx/Rx (e.g., the uplink transmissions and/or the downlink receptions) with the base station in the skipped/cancelled/deactivated MG occasion. In an example embodiment, the base station may transmit, to the wireless device, the indication via a RRC message, a MAC CE and/or DCI. In an example, the RRC message, the MAC CE and/or the DCI may comprise one or more bits indicating the skipped/cancelled/deactivated MG occasion. For example, a value of the one or more bits may indicate that a next MG occasion after the reception of the indication should be skipped/cancelled/deactivated by the wireless device. The MG occasion may be the nearest MG occasion after the indication. The MG occasion may be the nearest MG occasion after the indication and at least a time offset away from the indication (e.g., the MG occasion may be the nearest MG occasion which is at least 5 ms after the indication). In an example, the wireless device may perform the Tx/Rx (e.g., the uplink transmissions and/or the downlink receptions) with the base station via one or more Tx/Rx resources in the skipped/cancelled/deactivated MG occasion. The one or more Tx/Rx resources may have a first priority. The first priority may be a priority of a logical channel (LCH) to be transmitted using the one or more Tx/Rx resources. The MG occasion may have a second priority. The second priority may be a priority of the MG configuration (e.g., referring FIG. 7 and FIG. 8) configuring the MG occasion. The wireless device may determine to skip/cancel/deactivate the MG occasion (e.g., to enable the Tx/Rx in the MG occasion) based on the receiving of the indication and the first priority being higher than the second priority. The wireless device may determine not to skip/cancel/deactivate the MG occasion (e.g., to enable the Tx/Rx in the MG occasion) based on the receiving of the indication and the first priority being lower than the second priority.

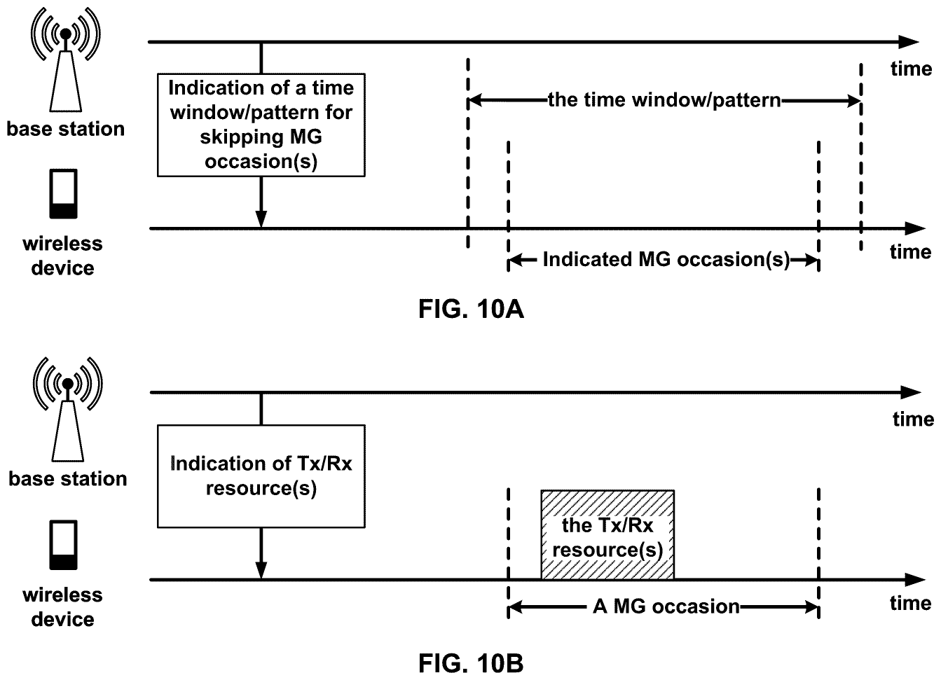

FIG. 10A and FIG. 10B illustrate examples of enabling Tx/Rx in gaps/restrictions of RRM measurements. In FIG. 10A and referring to FIG. 7 and FIG. 8, a base station (e.g., network) may transmit a message to a wireless device for configuring a MG configuration. The message may be an RRC message comprising configuration parameters of the MG configuration. The base station may transmit to the wireless device an indication of a time window/pattern for skipping/cancelling/deactivating one or more MG occasions of the MG configuration. The indication may enable the wireless device to perform uplink transmissions and/or downlink receptions (e.g., Tx/Rx) in the one or more MG occasions (e.g., and/or scheduling restrictions) of the MG configuration, when the one or more MG occasions overlap with the indicated time window/pattern. The indication may enable the wireless device to perform uplink transmissions and/or downlink receptions (e.g., Tx/Rx) in the one or more MG occasions (e.g., and/or scheduling restrictions) of the MG configuration, when the one or more MG occasions are within with the indicated time window/pattern. In response to the receiving of the indication, the wireless device may skip/cancel/deactivate the one or more MG occasions for the RRM measurements (e.g., not perform the RRM measurement in the skipped/cancelled/deactivated one or more MG occasions). The wireless device may perform Tx/Rx (e.g., the uplink transmissions and/or the downlink receptions) with the base station in the skipped/cancelled/deactivated one or more MG occasions. In an example embodiment, the base station may transmit, to the wireless device, the indication via a RRC message, a MAC CE and/or DCI. In an example, the RRC message, the MAC CE and/or the DCI may comprise one or more bits indicating a start time of the time window/pattern, a length of the time window/pattern, and/or a periodicity to repeat the time window/pattern. In an example, the wireless device may perform the Tx/Rx (e.g., the uplink transmissions and/or the downlink receptions) with the base station via one or more Tx/Rx resources in the one or more skipped/cancelled/deactivated MG occasions. The one or more Tx/Rx resources may have a first priority. The first priority may be a priority of a logical channel (LCH) to be transmitted using the one or more Tx/Rx resources. The one or more MG occasions may have a second priority. The second priority may be a priority of the MG configuration (e.g., referring FIG. 7 and FIG. 8) configuring the one or more MG occasions. The wireless device may determine to skip/cancel/deactivate the one or more MG occasions of the MG configuration (e.g., to enable the Tx/Rx in the one or more MG occasions of the MG configuration) based on the receiving of the indication and the first priority being higher than the second priority. The wireless device may determine not to skip/cancel/deactivate the one or more MG occasions of the MG configuration (e.g., to enable the Tx/Rx in the one or more MG occasions of the MG configuration) based on the receiving of the indication and the first priority being lower than the second priority.

In FIG. 10B and referring to FIG. 7 and FIG. 8, a base station (e.g., network) may transmit a message to a wireless device for configuring a MG configuration. The message may be an RRC message comprising configuration parameters of the MG configuration. The base station may transmit to the wireless device an indication of one or more Tx/Rx resources. The one or more Tx/Rx resources may overlap with (e.g., or within) a MG occasion of the MG configuration. The indication may enable the wireless device to perform uplink transmissions and/or downlink receptions (e.g., Tx/Rx) in the MG occasion (e.g., and/or scheduling restrictions) of the MG configuration. In response to the receiving of the indication, the wireless device may skip/cancel/deactivate the MG occasion for the RRM measurements (e.g., not perform the RRM measurement in the skipped/cancelled/deactivated one or more MG occasions). The wireless device may perform Tx/Rx (e.g., the uplink transmissions and/or the downlink receptions) with the base station in the skipped/cancelled/deactivated MG occasion. In an example embodiment, the base station may transmit, to the wireless device, the indication via a RRC message, a MAC CE and/or DCI. In an example, the one or more Tx/Rx resources may comprise one or more downlink resources. The RRC message may comprise configuration parameters for semi-persistent scheduling (SPS) the one or more downlink resources. In another example, the DCI may dynamically schedule the one or more downlink resources. In an example, the one or more Tx/Rx resources may comprise one or more uplink resources. The RRC message may comprise configuration parameters of an uplink configured grant (CG) configuration. An uplink configured grant, based on the uplink CG configuration, may comprise the one or more uplink resources. The uplink CG may be a type 1 CG or a type 2 CG. In another example, the DCI may dynamically schedule the one or more uplink resources. In an example, the one or more Tx/Rx resources may have a first priority. The first priority may be a priority of a logical channel (LCH) to be transmitted using the one or more Tx/Rx resources. The MG occasion may have a second priority. The second priority may be a priority of the MG configuration (e.g., referring FIG. 7 and FIG. 8) configuring the MG occasion. The wireless device may determine to skip/cancel/deactivate the MG occasion (e.g., to enable the Tx/Rx in the MG occasion) based on the receiving of the indication and the first priority being higher than the second priority. The wireless device may determine not to skip/cancel/deactivate the MG occasion (e.g., to enable the Tx/Rx in the MG occasion) based on the receiving of the indication and the first priority being lower than the second priority.

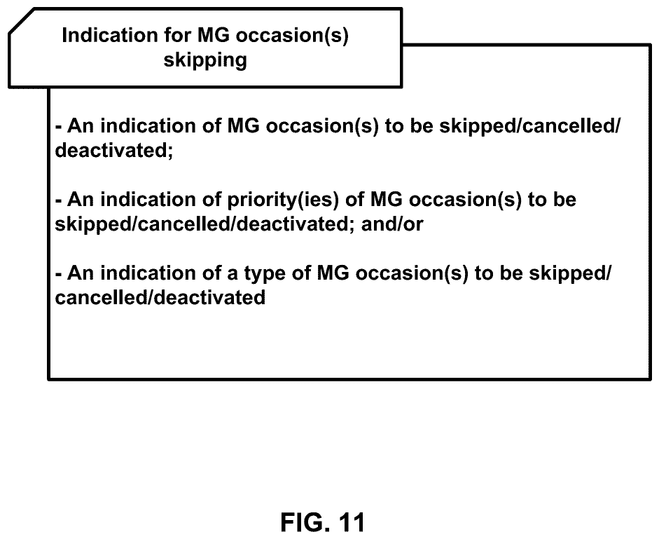

FIG. 11 illustrates an example of an indication for skipping/canceling/deactivating one or more MG occasions.

In an example of FIG. 11, a base station (e.g., network) may transmit an indication to a wireless device for skipping/canceling/deactivating one or more MG occasions (e.g., or an indication for enabling Tx/Rx in the one or more MG occasions). The base station may transmit a message/signaling for conveying the indication. The message/signaling may comprise an RRC message, a MAC CE and/or DCI.

In an example of FIG. 11, the message/signaling for the indication may comprise a first parameter indicating locations of the one or more MG occasions to be skipped by the wireless device. Referring to FIG. 9, the first parameter may indicate (e.g., the locations) that the one or more MG occasions to be skipped are the nearest one or more MG occasions after receiving the message/signaling (e.g., the indication) by the wireless device. Referring to FIG. 9, t the first parameter may indicate that the one or more MG occasions to be skipped are the nearest one or more MG occasions a time offset away after receiving the message/signaling (e.g., the indication) by the wireless device. Referring to FIG. 10A, the first parameter may indicate that the one or more MG occasions to be skipped are the one or more MG occasions overlapping with (e.g., or within) a time window/pattern. Referring to FIG. 10B, the first parameter may indicate that the one or more MG occasions to be skipped are the one or more MG occasions overlapping with (e.g., or within) one or more Tx/Rx resources to be transmitted within the one or more MG occasions. In response to receiving the indication from the base station, the wireless device may skip/cancel/deactivate the one or more MG occasions based on the indication. The wireless device may enable uplink transmissions and/or downlink receptions via the one or more Tx/Rx resources overlapped with the one or more MG occasions.

In an example of FIG. 11, the message/signaling for the indication may comprise a second parameter indicating a first priority for skipping/cancelling/deactivating the one or more MG occasions. In an example and referring to FIG. 7 and FIG. 8, the first priority may be the same as a second priority of a MG configuration configuring the one or more MG occasions. In another example, the first priority may be different from a second priority of a MG configuration configuring the one or more MG occasions. The first priority may be a priority threshold for the wireless device to determine whether to skip/cancel/deactivate the one or more MG occasions when the one or more MG occasions overlaps with one or more Tx/Rx resources.

In an example of FIG. 11, the message/signaling for the indication may comprise a third parameter indicating a type of the one or more MG occasions to be skipped. In an example and referring to FIG. 9, FIG. 10A, and FIG. 10B, the type of the one or more MG occasions may indicate that the one or more MG occasions would be used for only downlink receptions by the wireless device (e.g., or downlink transmissions by the base station). The type of the one or more MG occasions may indicate that the one or more MG occasions would be used for only uplink transmissions by the wireless device. The type of the one or more MG occasions may indicate that the one or more MG occasions would be used for both uplink transmissions and downlink receptions of the wireless device.

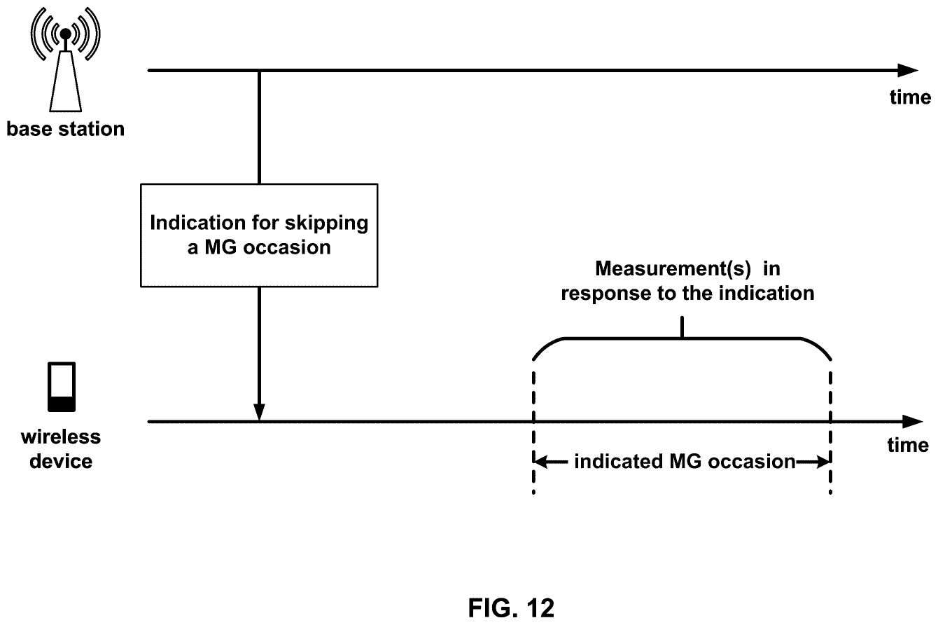

FIG. 12 illustrates an example of performing measurements in a skipped/cancelled/deactivated MG occasion.

In an example of FIG. 12 and referring to FIG. 7, a base station may transmit, to a wireless device, a first message comprising configuration parameters of a MG configuration. The MG configuration may comprise one or more MG occasions (e.g., one or more time intervals/gaps). The one or more MG occasions based on the MG configuration may be configured for a measurement by the wireless device. The measurement may be an RRM measurement. Referring to FIG. 7 and FIG. 8, the first message may be a first RRC message configuring the MG configuration. Based on the MG configuration and referring to FIG. 7 and FIG. 8, the one or more MG occasions may have a first priority (e.g., based on parameter gapPriority of the MG configuration). In another example, the MG configuration may be pre-configured to the wireless device. The wireless device may determine the one or more MG occasions based on the pre-configured MG configuration.

In an example of FIG. 12, the base station may transmit, to the wireless device, one or more second messages/signaling comprising an indication for skipping/canceling/deactivating a first MG occasion (e.g., indicated MG occasion in FIG. 12) of the one or more MG occasions. The one or more second messages/signaling may comprise a second RRC message, a MAC CE, and/or a DCI. The wireless device may receive the indication from the base station. The first MG occasion may overlap with one or more Tx/Rx radio resources in time domain. The one or more Tx/Rx radio resources may comprise one or more uplink resources for uplink transmissions and/or one or more downlink resources for downlink receptions. In an example, the uplink transmissions may comprise a PUCCH, a PUSCH, and/or an SRS transmission. In an example, the downlink receptions may comprise a PDCCH, a PDSCH, a tracking reference signal (TRS), a SSB, and/or a CSI-RS reception.

In an example of FIG. 12, the one or more second messages/signaling may comprise one or more bits. A first value of the one or more bits may indicate to skip a MG occasion. A second value of the one or more bits may indicate not to skip a MG occasion. In an example and referring to FIG. 9 to FIG. 11, the one or more second messages/signaling may indicate to skip the first MG occasion based on the first MG occasion being the nearest MG occasion or being the nearest MG occasion which is at least a time offset away from the indication. In an example and referring to FIG. 9 to FIG. 11, the one or more second messages/signaling may comprise one or more bits configuring a time window/pattern for skipping/cancelling/deactivating the first MG occasion if/when/based on the first MG occasion overlapping (e.g., or within) the time window/pattern. In an example and referring to FIG. 9 to FIG. 11, the one or more second messages/signaling may comprise/indicate the one or more Tx/Rx radio resources during the first MG occasion. In response to the reception of the indication for skipping/cancelling/deactivating the first MG occasion, the wireless device may skip/cancel/deactivate the first MG occasion based on the first MG occasion overlapping with the one or more Tx/Rx radio resources. In response to the reception of the indication for skipping/cancelling/deactivating the first MG occasion, the wireless device may determine to enable the uplink transmissions and/or the downlink receptions using the one or more Tx/Rx radio resources (e.g., but not performing the RRM measurement) during the first MG occasion based on the first MG occasion overlapping with the one or more Tx/Rx radio resources. In an example and referring to FIG. 9 to FIG. 11, the one or more second messages/signaling may further indicate a second priority of the one or more Tx/Rx radio resources. In an example, in response to the reception of the indication for skipping/canceling/deactivating the first MG occasion, the wireless device may skip/cancel/deactivate the first MG occasion based on the first MG occasion overlapping with the one or more Tx/Rx radio resources and the first priority of the first MG occasion be lower than the second priority of the one or more Tx/Rx radio resources. In an example, in response to the reception of the indication for skipping/canceling/deactivating the first MG occasion, the wireless device may determine to enable the uplink transmissions and/or the downlink receptions using the one or more Tx/Rx radio resources (e.g., but not performing the RRM measurement) during the first MG occasion based on the first MG occasion overlapping with the one or more Tx/Rx radio resources and the first priority of the first MG occasion be lower than the second priority of the one or more Tx/Rx radio resources.

In an example of FIG. 12, in response to the receiving of the indication for the skipping/cancelling/deactivating the first MG occasion and before the first MG occasion, the wireless device may determine the one or more Tx/Rx radio resources being not used the uplink transmissions and/or the downlink receptions with the base station. Based on the determining, the wireless device may perform the RRM measurement during the first MG occasion. The wireless device may transmit, to the base station and based on the RRM measurement, a measurement result of the RRM measurement.

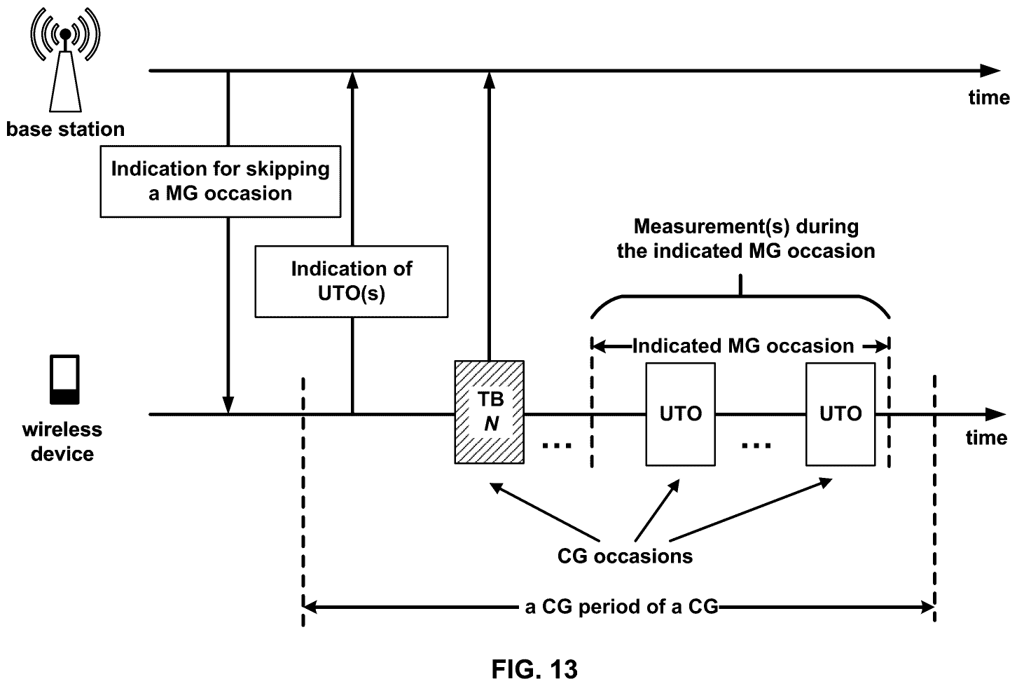

FIG. 13 illustrates an example of performing measurements in a skipped/cancelled/deactivated MG occasion.

In an example of FIG. 13 and referring to FIG. 12, a base station may transmit, to a wireless device, a first message comprising configuration parameters of a MG configuration. The MG configuration may comprise one or more MG occasions. The one or more MG occasions based on the MG configuration may be configured for an RRM measurement by the wireless device. The first message may be a first RRC message configuring the MG configuration. Based on the MG configuration, the one or more MG occasions may have a first priority (e.g., based on parameter gapPriority of the MG configuration). In another example, the MG configuration may be pre-configured to the wireless device. The wireless device may determine the one or more MG occasions based on the pre-configured MG configuration.

In an example of FIG. 13, the base station may transmit, to the wireless device, a second message comprising configuration parameters of an uplink configured grant (CG) configuration. The second message may be a second RRC message. The uplink CG configuration may indicate a CG period. The uplink CG configuration may indicate a plurality of CG occasions for uplink transmissions within the CG period. The uplink CG configuration may configure a second priority of the plurality of CG occasions. The CG configuration may be active. The uplink CG may be a type 1 and/or a type 2 CG. In another example, the uplink CG configuration may be pre-configured to the wireless device.

In an example of FIG. 13 and referring to FIG. 12, the base station may transmit, to the wireless device, one or more third messages/signaling comprising an indication for skipping/canceling/deactivating a first MG occasion (e.g., indicated MG occasion in FIG. 13) of the one or more MG occasions. The one or more third messages/signaling may comprise a third RRC message, a MAC CE, and/or a DCI. The first MG occasion may overlap with one or more CG occasions of the plurality of CG occasions in time domain. In an example, in response to the reception of the indication for skipping/canceling/deactivating the first MG occasion, the wireless device may skip/cancel/deactivate the first MG occasion based on the first MG occasion overlapping with the one or more CG occasions of the plurality of CG occasions. In an example, in response to the reception of the indication for skipping/canceling/deactivating the first MG occasion, the wireless device may determine to enable the uplink transmissions using the one or more CG occasions of the plurality of CG occasions (e.g., but not performing the RRM measurement) in the first MG occasion based on the first MG occasion overlapping with the one or more CG occasions of the plurality of CG occasions. In an example, in response to the reception of the indication for skipping/canceling/deactivating the first MG occasion, the wireless device may skip/cancel/deactivate the first MG occasion based on the first MG occasion overlapping with the one or more CG occasions of the plurality of CG occasions and the first priority of the first MG occasion being lower than the second priority of the plurality of CG occasions. In an example, in response to the reception of the indication for skipping/canceling/deactivating the first MG occasion, the wireless device may determine to enable the uplink transmissions using the one or more CG occasions of the plurality of CG occasions in the first MG occasion based on the first MG occasion overlapping with the one or more CG occasions of the plurality of CG occasions and the first priority of the first MG occasion be lower than the second priority of the plurality of CG occasions.

In an example of FIG. 13 and referring to FIG. 12, the wireless device may transmit, to the base station, one or more transport blocks (TBs) (e.g., transmission of a TB Nin a CG occasion in FIG. 13) via the plurality of CG occasions of the uplink CG. In response to the receiving of the indication for the skipping/cancelling/deactivating the first MG occasion and before the first MG occasion, the wireless device may determine the one or more CG occasions overlapped (e.g., within) the first MG occasion are unused transmission occasions (UTOs) for the uplink transmissions. The wireless device may transmit, to the base station, an indication of the UTOs. The indication of the UTOs may be a UTO-UCI via a PSSCH of the plurality of CG occasions (e.g., before the first MG occasion). Based on the transmitting the UTO-UCI indicating the UTOs of the first MG occasion, the wireless device may perform the RRM measurement during the first MG occasion. The wireless device may transmit, to the base station and based on the RRM measurement, a measurement result of the RRM measurement.

In an example of FIG. 13 and referring to FIG. 11, the indication for the skipping/canceling/deactivating the MG occasion further indicates a type of the first MG occasion. The wireless device may perform the RRM measurement during the first MG occasion based on the type of the first MG occasion indicating that the first MG occasion, overlapped with the UTOs, being used only for uplink transmissions (e.g., the first MG occasion only overlaps with uplink resources).

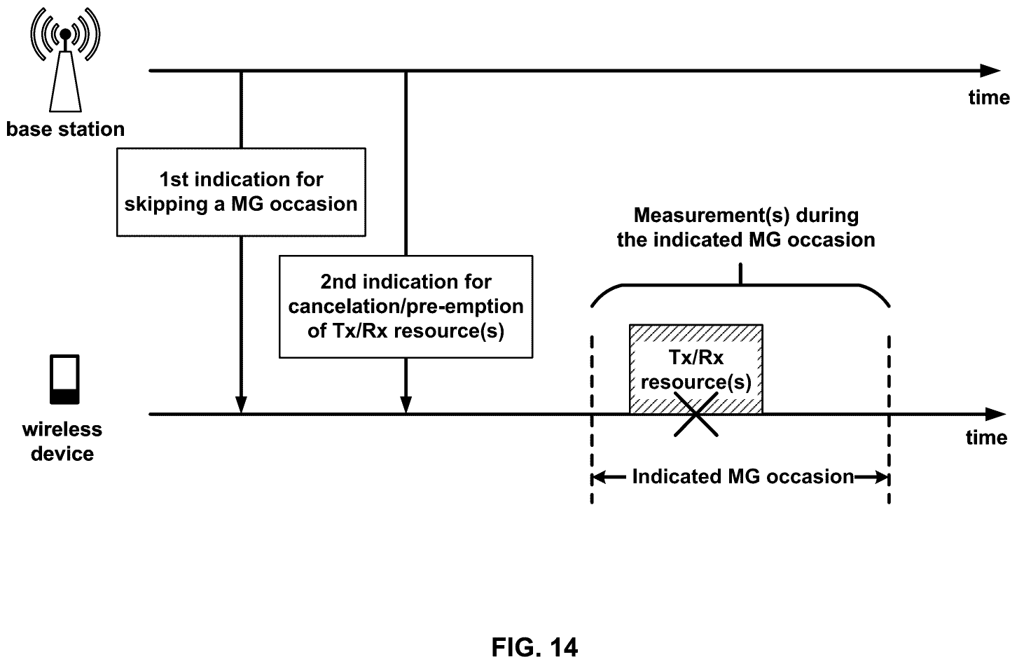

FIG. 14 illustrates an example of performing measurements in a skipped/cancelled/deactivated MG occasion.

In an example of FIG. 14 and referring to FIG. 12, a base station may transmit, to a wireless device, a first message comprising configuration parameters of a MG configuration. The MG configuration may comprise one or more MG occasions. The one or more MG occasions based on the MG configuration may be configured for an RRM measurement by the wireless device. The first message may be a first RRC message configuring the MG configuration. Based on the MG configuration, the one or more MG occasions may have a first priority (e.g., based on parameter gapPriority of the MG configuration). In another example, the MG configuration may be pre-configured to the wireless device. The wireless device may determine the one or more MG occasions based on the pre-configured MG configuration.

In an example of FIG. 14, the base station transmit, to the wireless device, one or more second messages/signaling for scheduling (e.g., SPS, CG, and/or dynamic scheduling) one or more Tx/Rx radio resources (e.g., Tx/Rx resources in FIG. 14) overlapped with the first MG occasion. The one or more second messages/signaling may comprise a second RRC message, a first MAC CE and/or a first DCI. The one or more Tx/Rx radio resources may comprise one or more uplink resources for uplink transmissions and/or one or more downlink resources for downlink receptions. In an example, the uplink transmissions may comprise a PUCCH, a PUSCH, and/or an SRS transmission. In an example, the downlink receptions may comprise a PDCCH, a PDSCH, a TRS, a SSB, and/or a CSI-RS reception.

In an example of FIG. 14 and referring to FIG. 12, the base station may transmit, to the wireless device, one or more third messages/signaling comprising a first indication for skipping/canceling/deactivating a first MG occasion (e.g., indicated MG occasion in FIG. 14) of the one or more MG occasions. The one or more third messages/signaling may comprise a third RRC message, a second MAC CE, and/or a second DCI. In response to the receiving of the first indication, the wireless device may determine to skip/cancel/deactivate the first MG occasion based on one or more Tx/Rx radio resources (e.g., Tx/Rx resources in FIG. 14) overlapping with the first MG occasion. In response to the receiving of the first indication, the wireless device may determine to enable uplink transmissions and/or downlink receptions with the base station using the one or more Tx/Rx radio resources in the first MG occasion based on one or more Tx/Rx radio resources (e.g., Tx/Rx resources in FIG. 14) overlapping with the first MG occasion. In an example and referring to FIG. 9 to FIG. 11, the one or more third messages/signaling may further indicate a second priority of the one or more Tx/Rx radio resources. In an example, in response to the reception of the indication for skipping/canceling/deactivating the first MG occasion, the wireless device may skip/cancel/deactivate the first MG occasion based on the first MG occasion overlapping with the one or more Tx/Rx radio resources and the first priority of the first MG occasion be lower than the second priority of the one or more Tx/Rx radio resources. In an example, in response to the reception of the indication for skipping/canceling/deactivating the first MG occasion, the wireless device may determine to enable the uplink transmissions and/or the downlink receptions using the one or more Tx/Rx radio resources (e.g., but not performing the RRM measurement) during the first MG occasion based on the first MG occasion overlapping with the one or more Tx/Rx radio resources and the first priority of the first MG occasion be lower than the second priority of the one or more Tx/Rx radio resources.

In an example of FIG. 14 and referring to FIG. 12, the base station may transmit, to the wireless device, a fourth message/signaling comprising a second indication for canceling and/or pre-empting the one or more Tx/Rx radio resources overlapping with the first MG occasion. In an example of uplink, the fourth message/signaling may be a DCI (e.g., DCI format 2_4) for notifying the one or more Tx/Rx radio resources (e.g., PRBs and OFDM symbols) where the wireless device cancels the uplink transmissions to the base station. In an example of uplink, the fourth message/signaling may be a DCI (e.g., DCI format 2_1) for notifying the one or more Tx/Rx radio resources (e.g., PRBs and OFDM symbols) where the wireless device assumes no downlink transmissions are intended (e.g., pre-emption of the one or more Tx/Rx radio resources for the downlink transmissions) for the wireless device.

In an example of FIG. 14 and referring to FIG. 12, in response to the receiving of the second indication, the wireless device may perform the RRM measurement during the first MG occasion. The wireless device may transmit, to the base station and based on the RRM measurement, a measurement result of the RRM measurement.

In an example of FIG. 14 and referring to FIG. 11, the first indication for the skipping/canceling/deactivating the first MG occasion may further indicate a type of the first MG occasion. In an example, the wireless device may perform the RRM measurement during the first MG occasion based on the type of the first MG occasion indicating that the first MG occasion, overlapped with the one or more Tx/Rx radio resources, being used only for uplink transmissions (e.g., the one or more Tx/Rx radio resources are uplink resources) and the second indication (e.g., via a DCI format 2_4) canceling the one or more Tx/Rx radio resources for the uplink transmissions. In an example, the wireless device may perform the RRM measurement during the first MG occasion based on the type of the first MG occasion indicating that the first MG occasion, overlapped with the one or more Tx/Rx radio resources, being used only for downlink receptions (e.g., the one or more Tx/Rx radio resources are downlink resources) and the second indication (e.g., via a DCI format 2_1) indicating pre-emption of the one or more Tx/Rx radio resources for the downlink receptions.

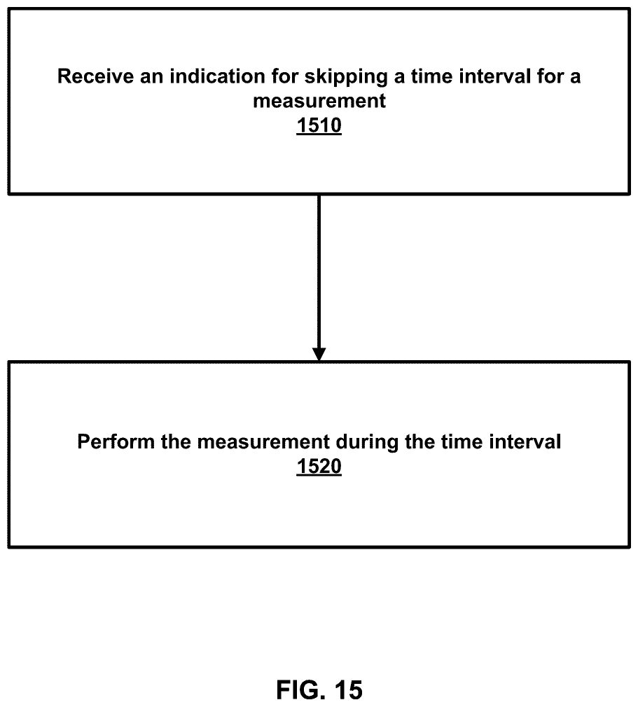

FIG. 15 illustrates an example flow diagram of performing measurements in a skipped/cancelled/deactivated MG occasion. At 1510, a wireless device may receive from a base statin an indication for skipping/cancelling/deactivating a time interval for a measurement. The time internal may be MG occasion of a MG configuration. The measurement may be an RRM measurement measuring SSB/CSI-RS of neighboring cells and/or other CCs. The RRM measurement may be for handover, beam switching, carrier aggregation, SCell activation/deactivation, etc. At 1520, the wireless device may perform the measurement during the time interval. In an example, one or more Tx/Rx radio resources for uplink transmission and/or downlink receptions may overlap with the time interval. The wireless device may perform the measurement during the time interval, which is indicated to be skipped for the uplink transmission and/or the downlink receptions, based on determining the one or more Tx/Rx radio resources being not used for the uplink transmission and/or the downlink receptions.

In an example, a base station may transmit to a wireless device, a RRC message comprising configuration parameters of a MG configuration for a RRM measurement by the wireless device. The base station may transmit, to the wireless device, an indication for skipping an MG occasion of the MG configuration, when/if the MG occasion overlaps with one or more radio resources in time domain. The base station may receive, from the wireless device and based on the RRM measurement, a measurement result of the RRM measurement.

In an example, the base station may receive a UTO-UCI from the wireless device. The UTO-UCI may indicate that the one or more radio resources overlapped with (e.g., within) the MG occasion are not used for uplink transmissions. The base station may receive the UTO-UCI is the MG occasion.

In an example, the base station may transmit to the wireless device a DCI indicating the one or more radio resources being not used for uplink transmissions and/or downlink receptions. The DCI may be for canceling the uplink transmissions using the one or more radio resources. The DCI may be for pre-empting the downlink transmissions using the one or more radio resources.

What is claimed is:

1. A method comprising:
receiving, by a wireless device and from a base station, a plurality of downlink control information (DCI) comprising a first DCI and a second DCI, wherein:
the first DCI indicates the wireless device to cancel a measurement gap (MG) occasion for a radio resource management (RRM) measurement; and
the second DCI indicates the wireless device to perform the RRM measurement during the MG occasion; and
in response to the receiving of the second DCI being later than the receiving of the first DCI, performing, based on the second DCI, the RRM measurement during the MG occasion.

2. The method of claim 1, wherein the first DCI comprises a first MG cancellation field.

3. The method of claim 2, wherein:
a first value of the first MG cancellation field indicates the wireless device to cancel the MG occasion; and
a second value the first MG cancellation field indicates the wireless device to perform the RRM measurement during the MG occasion.

4. The method of claim 3, wherein the first MG cancellation field in the first DCI has the first value.

5. The method of claim 4, wherein the first DCI is associated with the MG occasion.

6. The method of claim 5, wherein the association between the first DCI and the MG occasion is based on the MG occasion being an earliest MG occasion starting at least a time offset after the first DCI.

7. The method of claim 6, wherein the second DCI comprises a second MG cancellation field.

8. The method of claim 7, wherein the second MG cancellation field in the second DCI has the second value.

9. The method of claim 6, wherein the second DCI is associated with the MG occasion.

10. The method of claim 1, further comprises transmitting, to the base station, a measurement result of the RRM measurement.

11. A wireless device comprising:
one or more processors; and
memory storing instructions that, when executed by the one or more processors, cause the wireless device to:
receive, from a base station, a plurality of downlink control information (DCI) comprising a first DCI and a second DCI, wherein:
the first DCI indicates the wireless device to cancel a measurement gap (MG) occasion for a radio resource management (RRM) measurement; and
the second DCI indicates the wireless device to perform the RRM measurement during the MG occasion; and
in response to the receiving of the second DCI being later than the receiving of the first DCI, perform, based on the second DCI, the RRM measurement during the MG occasion.

12. The wireless device of claim 11, wherein the first DCI comprises a first MG cancellation field.

13. The wireless device of claim 12, wherein:
a first value of the first MG cancellation field indicates the wireless device to cancel the MG occasion; and
a second value the first MG cancellation field indicates the wireless device to perform the RRM measurement during the MG occasion.

14. The wireless device of claim 13, wherein the first MG cancellation field in the first DCI has the first value.

15. The wireless device of claim 14, wherein the first DCI is associated with the MG occasion.

16. The wireless device of claim 15, wherein the association between the first DCI and the MG occasion is based on the MG occasion being an earliest MG occasion starting at least a time offset after the first DCI.

17. The wireless device of claim 16, wherein the second DCI comprises a second MG cancellation field.

18. The wireless device of claim 17, wherein the second MG cancellation field in the second DCI has the second value.

19. The wireless device of claim 16, wherein the second DCI is associated with the MG occasion.

20. A system comprising:
a base station comprising:
one or more first processors; and
first memory storing first instructions that, when executed by the one or more first processors, cause the base station to:
transmit a plurality of downlink control information (DCI) comprising a first DCI and a second DCI; and
a wireless device comprising:
one or more second processors; and
second memory storing second instructions that, when executed by the one or more second processors, cause the wireless device to:
receive the plurality of DCI comprising the first DCI and the second DCI, wherein:
the first DCI indicates the wireless device to cancel a measurement gap (MG) occasion for a radio resource management (RRM) measurement; and
the second DCI indicates the wireless device to perform the RRM measurement during the MG occasion; and
in response to the receiving of the second DCI being later than the receiving of the first DCI, perform, based on the second DCI, the RRM measurement during the MG occasion.
